(19) United States
(12) Patent Application Publication
(10) Pub. No.: US 2013/0169121 A1
(43) Pub. Date: Jul. 4, 2013

(54) Television Housing and Method for Manufacturing the Same

(71) Applicant: CHEIL INDUSTRIES INC., Gumi-si (KR)

(72) Inventors: Jo Won LEE, Uiwang-si (KR); Kyuong Sik CHIN, Uiwang-si (KR); Min Jung JOO, Uiwang-si (KR); Seung Shik SHIN, Uiwang-si (KR)

(73) Assignee: CHEIL INDUSTRIES INC., Gumi-si (KR)

(21) Appl. No.: 13/723,381

(22) Filed: Dec. 21, 2012

(30) Foreign Application Priority Data
Dec. 29, 2011 (KR) 10-2011-0146561

(51) Int. Cl. H04N 5/64; B32B 37/14

(52) U.S. Cl. CPC H04N 5/64; B32B 37/14
USPC 312/7.2; 156/242

(57) ABSTRACT

A television housing has a structure including a stainless steel (SUS) frame; and a plastic member in contact with at least one side of the stainless steel frame. The plastic member includes (A) a polycarbonate resin, (B) a rubber modified aromatic vinyl graft copolymer resin, and (C) a non-adhesive glass fiber. The plastic member can have excellent properties in terms of appearance, gloss, surface roughness, and stiffness. In addition, the plastic member can be highly dimensionally stable.

### CROSS-REFERENCE TO RELATED APPLICATIONS

This application claims priority under 35 USC Section 119 to and the benefit of Korean Patent Application No. 10-2011-0146561 filed on Dec. 29, 2011, the entire disclosure of which is incorporated herein by reference.

### FIELD OF THE INVENTION

The present invention relates to a television housing and a method for manufacturing the same.

### BACKGROUND OF THE INVENTION

PC/ABS is a blend of polycarbonate (PC) and acrylonitrile-butadiene-styrene (ABS). PC/ABS is generally used as an exterior material for electronic products that require excellent physical properties, for example, high gloss, high flowability and good impact resistance.

PC/ABS products reinforced with glass fibers are currently being developed because of low stiffness and poor dimensional stability of PC/ABS.

Such glass fiber reinforced PC/ABS is used in products requiring good dimensional stability and high stiffness. Glass fiber reinforced PC/ABS is also widely used as a material for interior parts of electrical/electronic products.

However, inferior appearance quality of glass fiber reinforced resins limits their use in exterior parts of electronic products. That is, glass fibers are effective in achieving improved dimensional stability and stiffness but the glass fibers tend to protrude from PC/ABS blends, which limits their use in applications requiring a good appearance.

Thus there is a need to develop a material that is highly dimensionally stable and has high stiffness and also has a good appearance.

### SUMMARY OF THE INVENTION

The present invention provides a television housing that can have excellent properties in terms of gloss, appearance and surface roughness. The television housing includes a plastic member having good dimensional stability and high stiffness with good appearance, and a stainless steel (SUS) frame whose shrinkage is minimally different from that of the plastic member. The present invention further provides a method for manufacturing the television housing.

The television housing has a structure including a stainless steel (SUS) frame; and a plastic member in contact with at least one side of the stainless steel frame, wherein the plastic member includes (A) a polycarbonate resin, (B) a rubber modified aromatic vinyl graft copolymer resin, and (C) a non-adhesive glass fiber.

In an exemplary embodiment, the plastic member is produced by a steam molding process.

In an exemplary embodiment, the plastic member has a gloss of at least about 95, as measured in accordance with the method of ASTM D 2457, and a surface roughness (Ra) not greater than about 20 nm, as measured in accordance with the method of ASTM D 4417-B.

In an exemplary embodiment, the difference in shrinkage between the stainless steel (SUS) frame and the plastic member is not greater than about 0.003 cm/cm, as measured in accordance with the method of ASTM C356.

In an exemplary embodiment, the non-adhesive glass fiber (C) may have an average length of about 2 to about 5 mm and an average diameter of about 10 to about 20 μm.

In an exemplary embodiment, the non-adhesive glass fiber (C) is not exposed to the surface of the plastic member.

In an exemplary embodiment, the plastic member may include at least one additive selected from flame retardants, impact-reinforcing agents, anti-drip agents, antibacterial agents, heat stabilizers, antioxidants, release agents, light stabilizers, inorganic additives, surfactants, plasticizers, lubricants, antistatic agents, colorants, and the like, and combinations thereof.

The present invention also provides a method for manufacturing a television housing. The method includes: steam-molding (A) a polycarbonate resin, (B) a rubber modified aromatic vinyl graft copolymer resin, and (C) non-adhesive glass fiber into a plastic member; and bonding the plastic member to a stainless steel (SUS) frame.

In an embodiment, the steam molding is performed by a rapid heat cycle molding (RHCM) process.

### BRIEF DESCRIPTION OF DRAWING

FIG. 1 is a cross-sectional view of a television housing according to one embodiment of the present invention.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

Features and advantages of the invention will become apparent with reference to the accompanying drawings. In the drawings, the size of elements may be exaggerated for clarity and the present invention is not limited thereto.

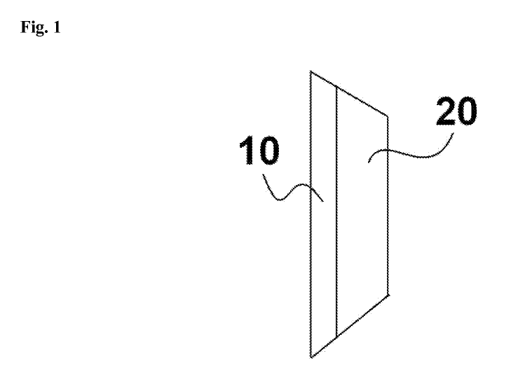

FIG. 1 is a cross-sectional view of a television housing according to one embodiment of the present invention. As illustrated in FIG. 1, the television housing has a structure including a stainless steel (SUS) frame 10 and a plastic member 20 in contact with at least one side of the stainless steel frame 10.

The stainless steel frame 10 and the plastic member 20 are not limited to the shapes illustrated in FIG. 1 and may have various shapes so long as at least one side of the stainless steel frame 10 is in contact with at least one side of the plastic member 20. There is no restriction as to the method for realizing the contact structure. For example, the stainless steel frame 10 may be brought into contact with the plastic member 20 by adhesion or insertion.

The stainless steel frame 10 may be a commercially available product for television housing application.

The plastic member 20 is not limited to a particular shape. The plastic member 20 includes (A) a polycarbonate resin, (B) a rubber modified aromatic vinyl graft copolymer resin, and (C) a non-adhesive glass fiber.

Hereinafter, the constituent components of the plastic member 20 will be specifically discussed.

(A) Polycarbonate Resin

The polycarbonate resin (A) may be produced by reacting one or more diphenols with phosgene, a halogen acid ester, a carboxylic acid ester or a combination thereof. The diphenols are represented by Formula I:

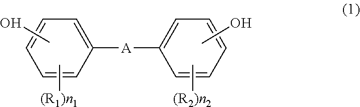

wherein:

A represents a single bond or is substituted or unsubstituted straight or branched C₁-C₃₀ alkylene, substituted or unsubstituted C₂-C₅ alkenylene, substituted or unsubstituted C₂-C₅ alkylidene, substituted or unsubstituted straight or branched C₁-C₃₀ haloalkylene, substituted or unsubstituted C₅-C₆ cycloalkylene, substituted or unsubstituted C₅-C₆ cycloalkenylene, substituted or unsubstituted C₅-C₁₀ cycloalkylidene, substituted or unsubstituted C₆-C₃₀ arylene, substituted or unsubstituted C₁-C₂₀ straight or branched alkoxylene, a halogen acid ester, a carboxylic acid ester, —CO—, —S—, or —SO₂—;

R₁ and R₂ are the same or different and are each independently substituted or unsubstituted C₁-C₃₀ alkyl or substituted or unsubstituted C₆-C₃₀ aryl; and n₁ and n₂ are the same or different and are each independently an integer from 0 to 4.

The term “substituted” used herein means that at least one hydrogen atom is a substituted with halogen atom, a hydroxyl group, a nitro group, a cyano group, an amino group, an azido group, an amidino group, a hydrazino group, a carbonyl group, a carbamyl group, a thiol group, an ester group, a carboxyl group or a salt thereof, a sulfonic acid group or a salt thereof, a phosphate group or a salt thereof, a C₁-C₂₀ alkyl group, a C₂-C₂₀ alkenyl group, a C₂-C₂₀ alkynyl group, a C₁-C₂₀ alkoxy group, a C₆-C₃₀ aryl group, a C₆-C₃₀ aryloxy group, a C₃-C₃₀ cycloalkyl group, a C₃-C₃₀ cycloalkenyl group, a C₃-C₃₀ cycloalkynyl group, or a combination thereof.

The diphenols represented by Formula I may be combined to constitute repeating units of the polycarbonate resin. Specific examples of the diphenols include without limitation hydroquinone, resorcinol, 4,4′-dihydroxydiphenyl, 2,2-bis(4-hydroxyphenyl)propane (referred to as ‘bisphenol-A’), 2,4-bis(4-hydroxyphenyl)-2-methylbutane, bis(4-hydroxyphenyl)methane, 1,1-bis(4-hydroxyphenyl)cyclohexane, 2,2-bis(3-chloro-4-hydroxyphenyl)propane, 2,2-bis(3,5-dimethyl-4-hydroxyphenyl)propane, 2,2-bis(3,5-dichloro-4-hydroxyphenyl)propane, 2,2-bis(3,5-dibromo-4-hydroxyphenyl)propane, bis(4-hydroxyphenyl)sulfoxide, bis(4-hydroxyphenyl)ketone, bis(4-hydroxyphenyl)ether, and the like, and combinations thereof. In exemplary embodiments, 2,2-bis(4-hydroxyphenyl)propane, 2,2-bis(3,5-dichloro-4-hydroxyphenyl)propane and/or 1,1-bis(4-hydroxyphenyl)cyclohexane, for example 2,2-bis(4-hydroxyphenyl)propane, may be used.

The polycarbonate resin can have a weight average molecular weight ranging from about 10,000 to about 200,000 g/mol, for example, from about 15,000 to about 80,000 g/mol, but the present invention is not limited to the use of polycarbonate with a molecular weight falling within the above ranges.

The polycarbonate resin (A) may be a copolymer or a mixture of copolymers produced using two or more diphenols that differ from one another. The polycarbonate resin (A) may also include without limitation linear polycarbonate resins, branched polycarbonate resins, polyester carbonate copolymer resins, and the like, and combinations thereof.

For example, the linear polycarbonate resin may be a bisphenol-A type polycarbonate resin. The branched polycarbonate resin may be produced, for example, by reacting a multifunctional aromatic compound, such as trimellitic anhydride, trimellitic acid, and the like, with one or more diphenols and a carbonate. The multifunctional aromatic compound may be included in an amount of about 0.05 to about 2 mole %, based on the total weight of the branched polycarbonate resin. The polyester carbonate copolymer resin may be produced by reacting a difunctional carboxylic acid with one or more diphenols and a carbonate. As the carbonate, there may be used, for example, a diaryl carbonate, such as diphenyl carbonate, and the like, or ethylene carbonate.

In exemplary embodiments, the polycarbonate resin (A) may have a melt flow index of about 5 to about 120 g/10 min, as measured at 300° C. and 1.2 kg in accordance with ISO 1133.

A combination of two or more polycarbonates having different melt flow indexes can be used. For example, a mixture of about 20 to about 60% by weight of a polycarbonate resin having a melt flow index of about 5 to about 15 g/10 min, about 20 to about 60% by weight of a polycarbonate resin having a melt flow index of about 16 to about 50 g/10 min, and about 5 to about 40% by weight of a polycarbonate resin having a melt flow index of about 51 to about 120 g/10 min may be used. In this case, the polycarbonate resin (A) can have a good balance of physical properties.

In some embodiments, the combination of two or more polycarbonates may include a polycarbonate resin having a melt flow index of about 5 to about 15 g/10 min in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 49, 50, 51, 52, 53, 54, 55, 56, 57, 58, 59, or 60% by weight. Further, according to some embodiments of the present invention, the amount of polycarbonate resin having a melt flow index of about 5 to about 15 g/10 can be in a range from about any of the foregoing amounts to about any other of the foregoing amounts.

In some embodiments, the combination of two or more polycarbonates may include a polycarbonate resin having a melt flow index of about 16 to about 50 g/10 min in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 49, 50, 51, 52, 53, 54, 55, 56, 57, 58, 59, or 60% by weight. Further, according to some embodiments of the present invention, the amount of polycarbonate resin having a melt flow index of about 16 to about 50 g/10 min can be in a range from about any of the foregoing amounts to about any other of the foregoing amounts.

In some embodiments, the combination of two or more polycarbonates may include a polycarbonate resin having a melt flow index of about 51 to about 120 g/10 min in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40% by weight. Further, according to some embodiments of the present invention, the amount of polycarbonate resin having a melt flow index of about 51 to about 120 g/10 min can be in a range from about any of the foregoing amounts to about any other of the foregoing amounts.

The plastic member 20 may include the polycarbonate resin (A) in an amount of about 60 to about 95% by weight, for example about 65 to about 90% by weight, based on the total weight (100% by weight) of the base resins (A) and (B) constituting the plastic member. In some embodiments, the plastic member 20 may include the polycarbonate resin (A) in an amount of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95% by weight. Further, according to some embodiments of the present invention, the amount of polycarbonate resin (A) can be in a range from about any of the foregoing amounts to about any other of the foregoing amounts.

When the plastic member 20 includes the polycarbonate resin (A) in an amount within this range, the plastic member 20 can exhibit a good balance of impact strength, heat resistance and processability.

(B) Rubber Modified Aromatic Vinyl Graft Copolymer Resin

The rubber modified aromatic vinyl graft copolymer resin (B) is present in a state in which a particulate rubbery polymer is dispersed in a matrix (continuous phase) composed of an aromatic vinyl polymer.

In one embodiment, the rubber modified aromatic vinyl graft copolymer resin (B) includes about 20 to about 50% by weight of a rubbery polymer unit, about 40 to about 60% by weight of an aromatic vinyl unit, and about 10 to about 30% by weight of a cyano vinyl unit.

In some embodiments, the rubber modified aromatic vinyl copolymer resin (B) may include a rubbery polymer in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 49, or 50% by weight. Further, according to some embodiments of the present invention, the amount of rubbery polymer can be in a range from about any of the foregoing amounts to about any other of the foregoing amounts.

In some embodiments, the rubber modified aromatic vinyl copolymer resin (B) may include an aromatic vinyl unit in an amount of about 40, 41, 42, 43, 44, 45, 46, 47, 48, 48, 49, 50, 51, 52, 53, 54, 55, 56, 57, 58, 59, or 60% by weight. Further, according to some embodiments of the present invention, the amount of aromatic vinyl unit can be in a range from about any of the foregoing amounts to about any other of the foregoing amounts.

In some embodiments, the rubber modified aromatic vinyl copolymer resin (B) may include a cyano vinyl unit in an amount of about 10, 11, 12, 13, 14, 15, 16, 17, 18, 19, 20, 21, 22, 23, 24, 25, 26, 27, 28, 29, or 30% by weight. Further, according to some embodiments of the present invention, the amount of cyano vinyl unit can be in a range from about any of the foregoing amounts to about any other of the foregoing amounts.

The rubber modified aromatic vinyl graft copolymer resin (B) can be produced by adding an aromatic vinyl monomer and optionally a monomer copolymerizable with the aromatic vinyl monomer to a rubbery polymer, followed by polymerization. The rubber modified aromatic vinyl graft copolymer resin may be produced by any known polymerization process, such as emulsion polymerization, suspension polymerization or bulk polymerization. The rubber modified aromatic vinyl graft copolymer resin is usually produced by extrusion of a mixture of (B1) a graft copolymer resin and (B2) a copolymer resin. In the case of bulk polymerization, the rubber modified aromatic vinyl graft copolymer resin may be produced by a one-step reaction process without the need to separately prepare the graft copolymer resin (B1) and the copolymer resin (B2). In either case, the final rubber modified aromatic vinyl graft copolymer resin (B) can include about 1 to about 30% by weight of the rubber (i.e. the rubbery polymer).

The rubber can have a Z-average particle size of about 0.1 to about 6.0 μm, for example, about 0.25 to about 3.5 μm. When the rubbery polymer has a Z-average particle size within this range, good physical properties can be obtained.

The rubber modified aromatic vinyl graft copolymer resin (B) used in the present invention may be produced by using the graft copolymer resin (B1) alone or the graft copolymer resin (B1) and the copolymer resin (B2) in combination. In exemplary embodiments, the graft copolymer resin (B1) can be blended with the copolymer resin (B2) taking into consideration the compatibility thereof.

(B1) Graft Copolymer Resin

The graft copolymer resin (B1) used in the present invention can be obtained by graft copolymerization of a rubbery polymer, an aromatic vinyl monomer, a monomer copolymerizable with the aromatic vinyl monomer, and optionally a monomer capable of imparting processability and heat resistance.

Examples of such rubbery polymers include without limitation diene rubbers, such as polybutadiene, poly(styrene-butadiene), poly(acrylonitrile-butadiene), and the like, saturated rubbers obtained by hydrogenation of the diene rubbers, isoprene rubbers, acrylic rubbers, such as polybutylacrylic acid, and the like, ethylene-propylene-diene monomer (EPDM) terpolymers, and the like, and combinations thereof. In exemplary embodiments, diene rubbers, such as butadiene rubbers, can be used.

The graft copolymer resin (B1) can include the rubbery polymer in an amount of about 5 to about 65% by weight, based on the total weight of the graft copolymer resin (B1), but is not limited to this range. In some embodiments, the graft copolymer resin (B1) can include the rubbery polymer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 49, 50, 51, 52, 53, 54, 55, 56, 57, 58, 59, 60, 61, 62, 63, 64, or 65% by weight. Further, according to some embodiments of the present invention, the amount of rubbery polymer can be in a range from about any of the foregoing amounts to about any other of the foregoing amounts.

The rubber (i.e. the rubbery polymer) particles can have an average size of about 0.1 to about 6 μm from the viewpoint of impact strength and appearance.

Examples of aromatic vinyl monomers suitable for use in the mixture of the graft copolymerizable monomer mixture include, but are not necessarily limited to, styrene, a-methylstyrene, β-methylstyrene, p-methylstyrene, p-t-butylstyrene, ethylstyrene, vinylxylene, monochlorostyrene, dichlorostyrene, dibromostyrene, vinylnaphthalene, and the like, and combinations thereof. Styrene can be used in exemplary embodiments.

For graft copolymerization, the graft copolymer resin (B1) can include the aromatic vinyl monomer in an amount of about 34 to about 94% by weight, based on the total weight of the graft copolymer resin (B1), but is not limited to this range. In some embodiments, the graft copolymer resin (B1) can include the aromatic vinyl monomer in an amount of about 34, 35, 36, 37, 38, 39, 40, 41, 42, 43, 44, 45, 46, 47, 48, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, or 94% by weight. Further, according to some embodiments of the present invention, the amount of aromatic vinyl monomer can be in a range from about any of the foregoing amounts to about any other of the foregoing amounts.

At least one monomer copolymerizable with the aromatic vinyl monomer may be incorporated into the graft copolymer resin (B1). Examples of copolymerizable monomers include without limitation cyano vinyl compounds, such as acrylonitrile, unsaturated nitrile compounds, such as ethacrylonitrile and methacrylonitrile, and the like. These copolymerizable monomers may be used alone or as a mixture thereof.

The graft copolymer resin (B1) may include the copolymerizable monomer in an amount of about 1 to about 30% by weight, based on the total weight of the graft copolymer resin (B1), but is not limited to this range. In some embodiments, the graft copolymer resin (B1) can include the copolymerizable monomer in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30% by weight. Further, according to some embodiments of the present invention, the amount of copolymerizable monomer can be in a range from about any of the foregoing amounts to about any other of the foregoing amounts.

Examples of monomers capable of imparting processability and heat resistance include without limitation acrylic acid, methacrylic acid, maleic anhydride, N-substituted maleimide, and the like, and combinations thereof.

The graft copolymer resin (B1) may include the monomer capable of imparting processability and heat resistance in an amount of about 0 to about 15% by weight, based on the total weight of the graft copolymer resin (B1), but is not limited to this range. In some embodiments, the graft copolymer resin (B1) can include the monomer capable of imparting processability and heat resistance in an amount of 0 (the monomer is not present), about 0 (the monomer is present), 1, 2, 3, 4, 5, 6, 7, 8, 9, 10, 11, 12, 13, 14, or 15% by weight. Further, according to some embodiments of the present invention, the amount of monomer capable of imparting processability and heat resistance can be in a range from about any of the foregoing amounts to about any other of the foregoing amounts.

(B2) Copolymer Resin

The copolymer resin (B2) can be produced by varying the ratio of the monomers other than the rubber in the components of the graft copolymer resin (B1) depending on the compatibility of the monomers. For example, the copolymer resin can be obtained by adding a styrene monomer, a monomer copolymerizable with the styrene monomer, and optionally a monomer capable of imparting processability and heat resistance, followed by copolymerization.

Examples of styrene monomers suitable for use in the production of the copolymer resin include, but are not necessarily limited to, styrene, α-methylstyrene, β-methylstyrene, p-methylstyrene, p-t-butylstyrene, ethylstyrene, monochlorostyrene, dichlorostyrene, dibromostyrene, and the like, and combinations thereof. In exemplary embodiments, styrene be used.

The copolymer resin (B2) can include the styrene monomer in an amount of about 60 to about 90% by weight, based on the total weight of the copolymer resin (B2), but is not limited to this range. In some embodiments, the copolymer resin (B2) can include the styrene monomer in an amount of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90% by weight. Further, according to some embodiments of the present invention, the amount of styrene monomer can be in a range from about any of the foregoing amounts to about any other of the foregoing amounts.

Examples of monomers copolymerizable with the styrene monomer include without limitation cyano vinyl compounds, such as acrylonitrile, and unsaturated nitrile compounds, such as ethacrylonitrile and methacrylonitrile. These copolymerizable monomers may be used alone or as a mixture thereof.

The copolymer resin (B2) can include the monomer copolymerizable with the styrene monomer in an amount of about 10 to about 40% by weight, based on the total weight of the copolymer resin (B2), but is not limited to this range. In some embodiments, the copolymer resin (B2) can include the copolymerizable monomer in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40% by weight. Further, according to some embodiments of the present invention, the amount of copolymerizable monomer can be in a range from about any of the foregoing amounts to about any other of the foregoing amounts.

Examples of monomers capable of imparting processability and heat resistance include without limitation acrylic acid, methacrylic acid, maleic anhydride, N-substituted maleimide, and the like, and combinations thereof.

The copolymer resin (B2) can include the monomer capable of imparting processability and heat resistance in an amount of about 0 to about 30% by weight, based on the total weight of the copolymer resin (B2), but is not limited to this range. In some embodiments, the copolymer resin (B2) can include the monomer capable of imparting processability and heat resistance in an amount of 0 (the monomer is not present), about 0 (the monomer is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30% by weight. Further, according to some embodiments of the present invention, the amount of monomer capable of imparting processability and heat resistance can be in a range from about any of the foregoing amounts to about any other of the foregoing amounts.

Examples of the rubber modified aromatic vinyl graft copolymer resin (B) that can be used in the present invention may include without limitation an acrylonitrile-butadiene-styrene copolymer resin (ABS resin), acrylonitrile-ethylene propylene rubber-styrene copolymer resin (AES resin), an acrylonitrile-acrylic rubber-styrene copolymer resin (AAS resin), and the like, and combinations thereof.

The rubber modified aromatic vinyl graft copolymer resin (B) used in the present invention can be a mixture of about 10 to about 100% by weight of the graft copolymer resin (B1) and about 0 to about 90% by weight of the copolymer resin (B2). In one embodiment, the rubber modified aromatic vinyl graft copolymer resin (B) can include about 55 to about 90% by weight of the graft copolymer resin (B1) and about 10 to about 45% by weight of the copolymer resin (B2). In another embodiment, the rubber modified aromatic vinyl graft copolymer resin (B) can include about 15 to about 50% by weight of the graft copolymer resin (B1) and about 50 to about 85% by weight of the copolymer resin (B2).

In some embodiments, the rubber modified aromatic vinyl graft copolymer resin (B) can include the graft copolymer resin (B1) in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100% by weight. Further, according to some embodiments of the present invention, the amount of the graft copolymer resin (B1) can be in a range from about any of the foregoing amounts to about any other of the foregoing amounts.

In some embodiments, the rubber modified aromatic vinyl graft copolymer resin (B) can include the copolymer resin (B2) in an amount of 0 (the copolymer resin (B2) is not present), about 0 (the copolymer resin (B2) is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90% by weight. Further, according to some embodiments of the present invention, the amount of the copolymer resin (B2) can be in a range from about any of the foregoing amounts to about any other of the foregoing amounts.

The plastic member may include the rubber modified aromatic vinyl graft copolymer resin (B) in an amount of about 5 to about 40% by weight, for example about 10 to about 35% by weight, based on the total weight (100% by weight) of the base resins (A) and (B) constituting the plastic member. In some embodiments, the plastic member may include the rubber modified aromatic vinyl graft copolymer resin (B) in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40% by weight. Further, according to some embodiments of the present invention, the amount of the rubber modified aromatic vinyl graft copolymer resin (B) can be in a range from about any of the foregoing amounts to about any other of the foregoing amounts.

When the plastic member includes the rubber modified aromatic vinyl graft copolymer resin (B) in an amount within this range, a good balance of impact strength, heat resistance and processability can be obtained.

(C) Non-Adhesive Glass Fiber

The non-adhesive glass fiber (C) used in the present invention refers to a glass fiber free from any adhesive organic material, such as a coupling agent, on the surface thereof.

The non-adhesive glass fiber (C) is not adhered to the matrix upon steam molding and is thus flowable. The non-adhesive glass fiber (C) migrates inside the plastic member upon molding. This migration prevents the non-adhesive glass fiber (C) from being exposed to the surface of the plastic member. The term ‘exposed’ used herein means that the non-adhesive glass fiber (C) is visible to the naked eye in the sunlight.

The non-adhesive glass fiber (C) used in the present invention can have an average length of about 2 to about 5 mm, for example about 2.5 to about 4.5 mm. When the non-adhesive glass fiber (C) has an average length within this range, it can be easy to feed the non-adhesive glass fiber (C).

The non-adhesive glass fiber (C) can have a diameter of about 10 to about 20 μm, for example about 10 to about 15 μm. When the non-adhesive glass fiber (C) has a diameter within this range, high stiffness can be maintained and minimal or no protrusions may be observed.

The non-adhesive glass fiber (C) may be circular or elliptical in cross-section. In exemplary embodiments, the non-adhesive glass fiber (C) can be elliptical. In an exemplary embodiment, the ratio of the longest diameter (a) to the shortest diameter (b), i.e. (a)/(b), of the non-adhesive glass fiber (C) may be from about 1.0 to about 1.2. Within this range, good dimensional stability can be achieved.

The plastic member can include non-adhesive glass fiber (C) in an amount of about 5 to about 20 parts by weight, for example about 8 to 17 parts by weight, based on about 100 parts by weight of a base resin including (A) and (B) constituting the plastic member. In some embodiments, the plastic member may include non-adhesive glass fiber (C) in an amount of about 5, 6, 7, 8, 9, 10, 11, 12, 13, 14, 15, 16, 17, 18, 19, or 20 parts by weight. Further, according to some embodiments of the present invention, the amount of the non-adhesive glass fiber (C) can be in a range from about any of the foregoing amounts to about any other of the foregoing amounts.

When the plastic member includes the non-adhesive glass fiber (C) in an amount within this range, good appearance can be realized.

The plastic member may further include a flame retardant to achieve improved flame retardancy. Examples of flame retardants suitable for use in the plastic member include, but are not necessarily limited to, phosphorus-based flame retardants and halogenated flame retardant. These flame retardant may be used alone or as a mixture thereof. A phosphorus-based flame retardant can be used in exemplary embodiments.

The phosphorus-based flame retardant refers to a general phosphorus-containing flame retardant. Examples of such phosphorus-based flame retardants include, but are not necessarily limited to, phosphate, phosphonates, phosphinates, phosphine oxides, phosphazenes, metal salts thereof, and the like, and combinations thereof.

In addition to the flame retardant, the plastic member may optionally further include one or more other additives. Examples of the additives include without limitation impact-reinforcing agents, anti-drip agents, antibacterial agents, heat stabilizers, antioxidants, release agents, light stabilizers, inorganic additives, surfactants, plasticizers, lubricants, antistatic agents, colorants, and the like, and combinations thereof.

The present invention further provides a method for manufacturing a television housing. The method includes: injecting the polycarbonate resin (A), the rubber modified aromatic vinyl graft copolymer resin (B), and the non-adhesive glass fiber (C) into a mold by steam molding, followed by release from the mold to produce a plastic member; and bonding the plastic member to a stainless steel (SUS) frame.

In an exemplary embodiment, the steam molding may be performed by a rapid heat cycle molding (RHCM) process. Specifically, according to the RHCM process, the mold can be heated to the glass transition temperatures (Tg) or higher of the resins using steam, and the resins can be injected into the mold. The preheating of the mold can improve the adhesion of the resins to the mold, thus facilitating impregnation of the non-adhesive glass fiber (C) into the resins to minimize the protrusion of the glass fiber. Then, the resins are cooled. The rapid heat cycle molding (RHCM) can be practiced by those with ordinary knowledge in the art to which the present invention belongs.

The plastic member thus produced may have a gloss of at least about 95, as measured in accordance with the method of ASTM D 2457, and a surface roughness (Ra) not greater than about 20 nm, as measured in accordance with the method of ASTM D 4417-B.

In an embodiment, the plastic member may have a gloss of about 96 to about 99, as measured in accordance with the method of ASTM D 2457, and a surface roughness (Ra) of about 0.1 to about 15 nm, as measured in accordance with the method of ASTM D 4417-B.

The plastic member can be highly dimensionally stable. Specifically, the plastic member may have a coefficient of linear thermal expansion (a) not greater than about 40 μm/(m° C.), as measured in accordance with the method of ASTM D-696. The difference in shrinkage between the stainless steel (SUS) frame and the plastic member may be not greater than about 0.003 cm/cm, as measured in accordance with the method of ASTM C356.

In an exemplary embodiment, the difference in shrinkage between the stainless steel (SUS) frame and the plastic member is not greater than about 0.002 cm/cm, as measured in accordance with the method of ASTM C356.

Next, the present invention will be described in more detail with reference to some examples. It should be understood that these examples are provided for illustration only and are not to be in any way construed as limiting the present invention. Descriptions of details apparent to those skilled in the art will be omitted herein.

### EXAMPLES

Details of components used in Examples 1-2 and Comparative Examples 1-4 are as follows:

(A) Polycarbonate Resin

A mixture of 40 wt % of a polycarbonate resin (PC-1) having a melt flow index (300° C., 1.2 kg) of 8 g/10 min, 41 wt % of a polycarbonate resin (PC-2) having a melt flow index of 20 g/10 min, and 19 wt % of a polycarbonate resin (PC-3) having a melt flow index of 62 g/10 min is used. The melt flow indexes are measured in accordance with ISO 1133.

(B) Rubber Modified Aromatic Vinyl Graft Copolymer Resins

(B1) g-ABS: A graft polymer of 55 wt % of an acrylonitrile-styrene copolymer includes a styrene monomer and acrylonitrile (SM/AN) in a weight ratio of 71/29 onto 45 wt % of a polybutadiene rubber (PBR) having a Z-average particle size of 310 nm.

(B2) SAN: A SAN resin having a melt flow index (MI, 200° C., 5 kg) of 5 g/10 min, an acrylonitrile content 24 wt %, and an Mw of 150,000 g/mol is used.

(C) Glass Fibers

(C1) A non-adhesive glass fiber having a diameter of 13 μm, a length of 3 mm, and a circular cross section is used.

(C2) A non-adhesive glass fiber having a diameter of 13 μm, a length of 4 mm, and a circular cross section is used.

(C3) Adhesive glass fiber having a diameter of 13 μm, a length of 3 mm, a circular cross section, and a surface treated with an epoxy is used.

(C4) Adhesive glass fiber having a diameter of 13 μm, a length of 3 mm, a circular cross section, and a surface treated with a silane coupling agent is used.

(C5) Adhesive glass fiber having a diameter of 13 μm, a length of 3 mm, a circular cross section, and a surface treated with a urethane is used.

### Examples 1-2 and Comparative Examples 1-3

Compositions are prepared as shown in Table 1. To each of the compositions are added 13 parts by weight of bisphenol A bis(diphenyl phosphate) (BDP, Daihachi), 0.8 parts by weight of Teflon (Trade name) 7AJ (DuPont, U.S.) as an anti-drip agent, 0.3 parts by weight of octadecyl 3-(3,5-di-t-butyl-4-hydrixyphenyl)propionate (IRGANOX 1076) as an antioxidant, and 0.4 parts by weight of fatty acid ester of neopentylpolyol (UNISTER H-476) as a lubricant. The mixture is injected by steam molding (RHCM) and released to produce a plastic member. The plastic member is produced under the following conditions: Injection temperature=240-270° C., steam temperature in the mold=150-170° C., mold temperature=130° C., heating time=10-15 sec, mold temperature upon release=130° C., cooling time=10-15 sec. The physical properties of the plastic member are measured by the following methods. The results are shown in Table 1.

### Comparative Example 4

The same composition as that of Example 1 is prepared. The composition is extruded in a 45Φ, 36 L/D twin screw type extruder at 250° C. to produce pellets. After drying at 80° C. for 4 hr, the pellets are injected using a 6 oz injection molding machine to produce specimens. The specimens are produced under the following conditions: molding temperature=250-280° C., mold temperature=60-150° C.

Methods for Evaluation of Physical Properties

1) Tensile elongation (%) is measured by ASTM D 638 for 2 mm thick specimens.

2) Gloss is measured by ASTM D 2457 (sample size: 20 cm×30 cm, thickness=1 to 2 t).

3) Surface roughness (Ra, m) is measured by ASTM D 4417-B (sample size: 20 cm×30 cm, thickness=1 to 2 t).

4) Shrinkage (cm/cm) is measured by ASTM C356 (sample size: 6 inch×6 inch, thickness=2.5 t).

TABLE 1
(parts by weight)

| | | | | Comparative | Comparative | Comparative | Comparative |
|---|---|---|---|---|---|---|---|
| | | Example 1 | Example 2 | Example 1 | Example 2 | Example 3 | Example 4 |
| (A) PC | | 78 | 78 | 78 | 78 | 78 | 78 |
| (B) | (B1) | 6 | 6 | 6 | 6 | 6 | 6 |
| | (B2) | 5 | 5 | 5 | 5 | 5 | 5 |

| | | | | | | |
|---|---|---|---|---|---|---|
| (C1) GF | 11 | — | — | — | — | 11 |
| (C2) GF | — | 11 | — | — | — | — |
| (C3) GF | — | — | 11 | — | — | — |
| (C4) GF | — | — | — | 11 | — | — |
| (C5) GF | — | — | — | — | 11 | — |
| Molding process | Steam | Steam | Steam | Steam | Steam | Extrusion/injection |
| | molding | molding | molding | molding | molding | |
| Tensile elongation | 5.0 | 5.9 | 3.4 | 3.3 | 4.6 | — |
| (%) | | | | | | |
| Gloss | 98 | 97 | 92 | 92 | 93 | 92 |
| Surface roughness | 10 nm | 10 nm | 50 nm | 50 nm | 50 nm | 130 nm |
| (Ra) | | | | | | |
| Shrinkage (cm/cm) | 0.002 | 0.002 | 0.002 | 0.004 | 0.004 | 0.002 |

As can be seen from the results in Table 1, the plastic members of Examples 1-2 show satisfactory results in terms of appearance, elongation, gloss, surface roughness and shrinkage. In contrast, the plastic members of Comparative Examples 1-3, which are produced using the surface-treated glass fibers instead of the non-adhesive glass fibers, show low gloss values, low tensile strength values and high surface roughness values with poor appearance. The specimen of Comparative Example 4 produced by extrusion/injection instead of steam molding (RHCM) has a greatly reduced gloss and a significantly increased surface roughness with poor appearance.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A television housing having a structure comprising:
a stainless steel (SUS) frame; and
a plastic member in contact with at least one side of the stainless steel frame,
wherein the plastic member comprises (A) a polycarbonate resin, (B) a rubber modified aromatic vinyl graft copolymer resin, and (C) a non-adhesive glass fiber.

2. The television housing according to claim 1, wherein the plastic member is produced by a steam molding process.

3. The television housing according to claim 1, wherein the plastic member has a gloss of at least about 95, as measured in accordance with the method of ASTM D 2457, and a surface roughness (Ra) not greater than about 20 nm, as measured in accordance with the method of ASTM D 4417-B.

4. The television housing according to claim 1, wherein the difference in shrinkage between the stainless steel (SUS) frame and the plastic member is not greater than about 0.003 cm/cm, as measured in accordance with the method of ASTM C356.

5. The television housing according to claim 1, wherein the non-adhesive glass fiber (C) has an average length of about 2 to about 5 mm and an average diameter of about 10 to about 20 μm.

6. The television housing according to claim 1, wherein the non-adhesive glass fiber (C) is not exposed to the surface of the plastic member.

7. The television housing according to claim 1, wherein the plastic member further includes a flame retardant, impact-reinforcing agent, anti-drip agent, antibacterial agent, heat stabilizer, antioxidant, release agent, light stabilizer, inorganic additive, surfactant, plasticizer, lubricant, antistatic agent, colorant or a combination thereof.

8. A method for manufacturing a television housing, comprising:
steam-molding (A) a polycarbonate resin, (B) a rubber modified aromatic vinyl graft copolymer resin, and (C) a non-adhesive glass fiber into a plastic member; and
bonding the plastic member to a stainless steel (SUS) frame.

9. The method according to claim 8, wherein the steam molding is performed by a rapid heat cycle molding (RHCM) process.
